(19) United States
(12) Patent Application Publication
(10) Pub. No.: US 2010/0080005 A1
(43) Pub. Date: Apr. 1, 2010

(54) Lighting device with optimized emission

(76) Inventor: Massimo Gattari, Potenza Picena (IT)

Correspondence Address: ABELMAN, FRAYNE & SCHWAB, 666 THIRD AVENUE, 10TH FLOOR, NEW YORK, NY, 10017, US

(21) Appl. No.: 12/455,713

(22) Filed: Jun. 5, 2009

(30) Foreign Application Priority Data
Oct. 1, 2008 (EP) 08425645.2

(51) Int. Cl. F21V 29/00; F21S 6/00

(52) U.S. Cl. 362/294; 362/257

(57) ABSTRACT

The present invention relates to a lighting device with optimized emission comprising a casing having a concave internal profile and adapted to house at least one light source—equipped with appropriate supporting and fastening means and with appropriate power supplying means—and a frame for housing a screen, characterized in that it has a generally concave curvature such that, for every main emitting direction of the light beam of said at least one light source, it is substantially normal to the direction of the light emission itself.

### FIELD OF THE INVENTION

The present invention relates to the technical field of lighting devices and apparatuses, particularly to devices including multiple light sources.

### STATE OF THE ART

In the field of lighting devices and apparatuses, one of the most important parameters to be taken into consideration during their design consists of the set of photometric characteristics of the emitted light beam, including its orientation.

For each lighting device, in fact, there exists an optimal lighting profile related to the area to be illuminated. In reality, there is always a certain part of the produced light beam that deviates from the optimal profile, and is normally due to the reflections that the light beam emitted by the lighting element undergoes when it crosses the screen, made of glass or transparent material, of the lighting device.

More specifically, in the case of flat screens, a certain percentage of the emitted light beam is reflected into the optical cavity in accordance to the optics laws regarding the refraction. On the other hand, in the case of convex screens, reflections of the light rays are also created in undesired directions, such as occurs, for example, when part of the light emission is reflected upwards or is deviated to undesired directions. This case may constitute an even greater drawback when, as in the case of outdoor lighting, standards exist that must be respected regarding light pollution. According to these standards, in fact, particular importance is placed on the evaluation and control of certain parameters related to the lighting apparatus used, such as, for example, limitations on upward emissions.

Other parameters then relate to performance characteristics such as the useful portion of the flow, which is the index of the flow fraction that the apparatus actually sends to the area to be illuminated, and provides direct information about the quantity of light that the lighting apparatus in question sends to the part concerned and beyond the latter. One of these parameters is the so-called DLOR (Downward Light Output Ratio), or downward output of the apparatuses, defined as the ratio between the quantity of light emitted downward and the total quantity of light emitted. Lastly, in the apparatuses using traditional sources, we have a percentage of the light flow which is directed towards unwanted areas and represents a lowering of the energy output of the lighting device and therefore, in the last analysis, a waste of energy that should be avoided or at least limited. The energy waste typical of many devices according to the state of the art is also responsible for localized overheating that may lead to faults and that, in general, contributes to shortening the average lifetime of the components used. Especially in the case of multiple sources (as in the case of LEDs), the need to select particular lighting directions often leads to the arrangement of said light sources in different assemblies placed at determined points of the lamp housing them, with apparent negative consequences on the dissipation of the energy dispersed at those points.

There is therefore a clear need for lighting apparatuses adapted to optimize their emission profile without compromising an efficient control of the energy dispersed by the light sources used, so as to solve the technical problems described above.

### SUMMARY OF THE INVENTION

A lighting apparatus including: at least one concave screen characterized by a curvature that, for every main direction of light exiting it, is substantially normal to the light emission direction, and a multiplicity of light sources arranged so as to optimize the light emission according to certain selected directions and the thermal dissipation caused by said light sources.

### BRIEF DESCRIPTION OF DRAWINGS

FIG. 1 shows a top view of the device subject of the present invention.

FIG. 2 shows a bottom view of the device subject of the present invention.

FIG. 3 shows a cut-away view of the device subject of the present invention.

### DETAILED DESCRIPTION OF THE INVENTION

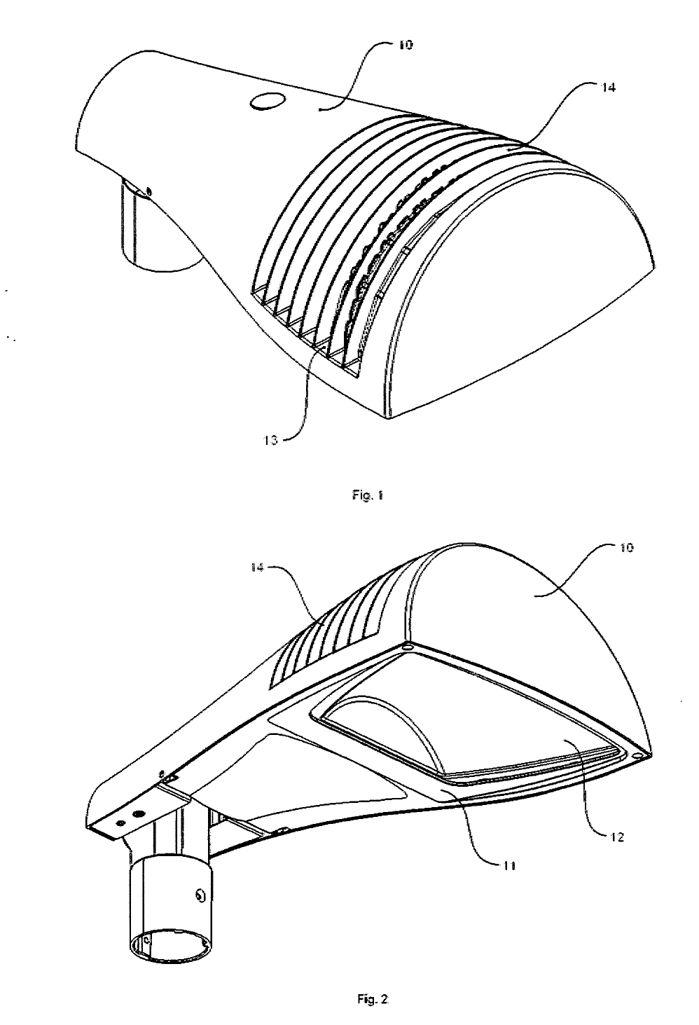

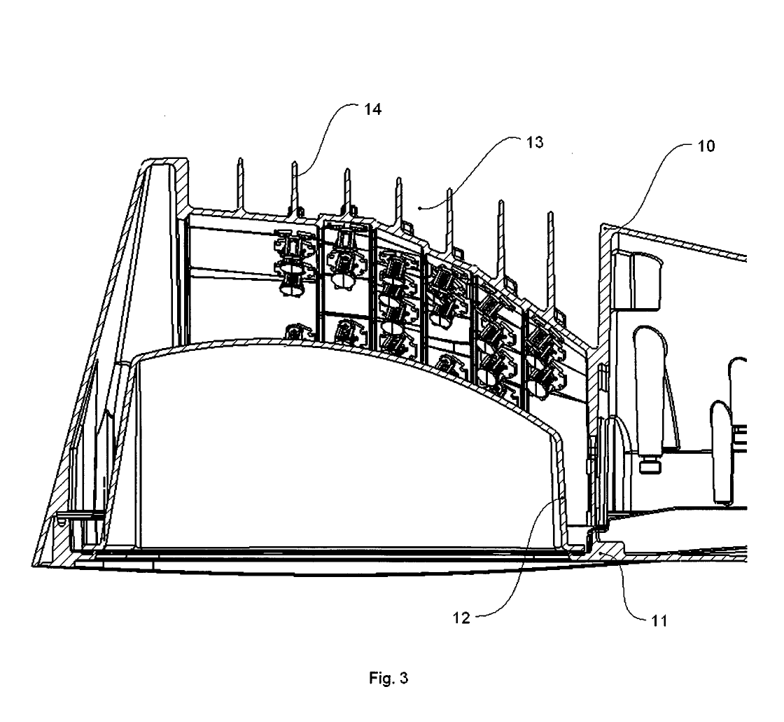

With reference to FIG. 1, the device according to the present invention includes a casing 10 adapted to house at least one light source—equipped with appropriate supporting and fastening means and with appropriate power supplying means—and a frame 11 for housing a screen 12 characterized in that it has a generally concave curvature such that, for every main emitting direction of the light beam of said at least one light source, it is substantially normal to the direction of the light emission itself. In this manner, the light emitted by said at least one light source will not generate any reflections in directions other than those desired, thus minimizing the fraction of the light flow produced which is sent beyond the zone to be illuminated.

In particular, the curvature profile of said screen may be shaped so as not to allow any light emission upwards with respect to the horizontal direction.

Said generally concave curvature profile of said screen may be formed by a single, continuous surface, correctly orthogonal to the corresponding light beams from the light sources, or by a surface which in turn consists of a set of smaller surfaces, each characterized by being orthogonal to the corresponding incident light beam.

The screen of the device according to the present invention may be made of glass or suitable plastic material, provided with the appropriate properties of transparency to visible light.

Said casing 10 is characterized by a concave internal profile and includes supporting and fastening means for said light sources, preferably in the form of Light Emitting Diodes or LEDs. Said supporting and fastening means are arranged and formed so as to ensure that the lighting produced by each individual light source used has a specific orientation substantially orthogonal to the portion of said screen 12 corresponding thereto. In addition, in a preferred embodiment of the present invention, the external part of said casing 10 is equipped with a series of grooves 13 delimited by fins 14. Said fins 14 are arranged at said supporting and fastening means, which are therefore arranged in rows substantially parallel and exactly corresponding to said fins 14, which thus act as heat sinks for the heat produced by said light sources when working.

Preferably, said grooves are constructed so as to allow the rain to effectively flow out and to prevent the stagnation of water in the event that the device according to the present invention is used outdoors. To this aim, said casing 10 is characterized by a rounded profile and said fins 14 describe arcs that substantially extend from one end of said casing to the other.

1. A lighting device comprising a casing having a concave internal profile adapted to house at least one light source—equipped with appropriate supporting and fastening means and with appropriate power supplying means—and a frame for housing a screen, having a generally concave curvature such that, for every main emitting direction of the light beam of said at least one light source, it is substantially normal to the direction of the light emission itself.

2. A device according to claim 1, wherein the curvature profile of said screen is shaped so as not to allow any light emission upwards with respect to the horizontal direction.

3. A device according to claim 2, wherein said generally concave curvature profile of said screen is formed by a single, continuous surface, correctly orthogonal to the corresponding light beams from said light sources.

4. A device according to claim 2, wherein said generally concave curvature profile of said screen is formed by a surface that in turn consists of a set of smaller surfaces, each being orthogonal to the corresponding incident light beam.

5. A device according to claim 1, wherein said supporting and fastening means are arranged and formed so as to ensure that the lighting produced by each individual light source used has a specific orientation substantially orthogonal to the portion of said screen corresponding thereto.

6. A device according to claim 1, wherein the external part of said casing is equipped with a series of grooves delimited by fins.

7. A device according to claim 6, wherein said supporting and fastening means are arranged in substantially parallel rows.

8. A device according to claim 7, wherein said fins are arranged at said supporting and fastening means such that they act as heat sinks for the heat produced by said light sources when working.

9. A device according to claim 6, wherein said grooves are constructed so as to allow the rain to effectively flow out and to prevent the stagnation of water in the event that the device according to the present invention is used outdoors.

10. A device according to claim 1, wherein said casing is characterized by a rounded profile and said fins describe arcs that substantially extend from one end of said casing to the other.
